(19) United States
(12) Patent Application Publication
(10) Pub. No.: US 2025/0170630 A1
(43) Pub. Date: May 29, 2025

(54) METHOD AND APAPRATUS FOR TREATING CONTAMINATED SOIL

(71) Applicant: Auxilium Developments Ltd., Guelph (CA)

(72) Inventor: Colin MORRELL, Guelph (CA)

(21) Appl. No.: 18/961,585

(22) Filed: Nov. 27, 2024

Related U.S. Application Data
(60) Provisional application No. 63/603,678, filed on Nov. 29, 2023.

(51) Int. Cl. B09C 1/02

(52) U.S. Cl. CPC B09C 1/02

(57) ABSTRACT

The disclosure is directed at a method and apparatus for treating contaminated soil. The disclosure includes a mixing apparatus that treats the contaminated soil by separating the contaminants in the soil and mass transferring the contaminants to a liquid, such as process water. The mixing apparatus includes a set of screens which are positioned to increase dissipation rates.

### CROSS-REFERENCE TO OTHER APPLICATIONS

This disclosure claims priority from U.S. Provisional Application No. 63/603,678 filed Nov. 29, 2023, which is hereby incorporated by reference.

### FIELD

The disclosure relates generally to remediation technologies for contaminated soil and, more specifically, to a method and apparatus for treating contaminated soil.

### BACKGROUND

The discharge of aqueous film-forming foam (AFFF), such as for fire training and firefighting activities, has resulted in PFAS-impacted soil source zones throughout the world. At these source zones, the presence of PFAS can lead to leaching or migration of the PFAS through the vadose zone which may result in widespread groundwater contamination, causing risk for human and environmental receptors. To mitigate future groundwater impacts, cost-effective and field-proven technologies are needed for contaminated soils to prevent or reduce the migration of PFASs from soil into groundwater. Current soil treatment options include excavation and landfill disposal, destructive technologies such as incineration and thermal desorption, stabilization methods designed to limit leaching and soil washing, however, all these techniques are either limited and/or expensive for PFAS-impacted soils.

Current solutions for treatment of PFAS-impacted soil present significant drawbacks. Incineration or any form of thermal treatment is expensive and carbon intensive emitting significant greenhouse gas emissions. Thermal techniques also present concern over incomplete combustion by-products in the off-gas emissions that may be as toxic or more toxic than the PFAS in the soil being treated. Adsorption and stabilization techniques do not remove the PFAS mass from the soil but simply sorb the leachable portion to protect groundwater and are not currently proven to sorb the PFAS for more than five years. Soil washing is not effective in reducing PFAS concentrations in fine-grained soils and may not be able to treat coarse-grained soils in accordance with emerging legal regulations.

Therefore, the disclosure is directed at a novel method and apparatus for treating PFAS and other contaminants in soil.

### SUMMARY

The present disclosure is directed to a method of increasing the mass transfer of contaminants that have been adsorbed to soil particles using a mixing apparatus designed to create an intense and turbulent mixing condition. The method and system of the disclosure is designed to overcome mass transfer limitations of contaminants, such as, but not limited to, PFAS and maximize or increase the desorption of the contaminants from the soil particles. The present disclosure addresses drawbacks experienced with current solutions because it creates a condition that allows the contaminants bound to both the coarse-and fine-grained soil to be transferred to an aqueous phase or process water effectively during soil treatment reducing the contaminants bound to the soil.

In one embodiment, the disclosure is directed at a more reliable and cost-effective method and system for soil treatment that can improve removal of the total mass of PFAS bound to the soil, treating both total and leachable contaminant concentrations.

In one aspect of the disclosure, there is provided a method for treating contaminated soil including mixing the contaminated soil with process water to produce a contaminated slurry; and pumping the contaminated slurry through a mixing apparatus to separate the contaminants from the soil thereby increasing a mass transfer of sorbed contaminants from the contaminated soil into the process water and producing a treated soil and a contaminated process water; wherein the mixing apparatus includes a set of mixing chambers separated by a set of mixing screens, the mixing screens positioned to increase dissipation rates within the mixing chambers downstream from the mixing screens.

In another aspect, the method further includes filtering the contaminated soil to reduce a size of particles within the contaminated soil before mixing the contaminated soil with process water. In yet another aspect, the method further includes passing the treated soil and the contaminated process water to a dewatering component. In a further aspect, the method includes directing the contaminated process water to a water treatment apparatus; and collecting the treated soil in a collection area. In yet a further aspect, the method includes pumping the contaminated slurry through the mixing apparatus a predetermined number of times to meet a required residence treatment time for the contaminated soil.

In another aspect, the method includes adding at least one chemical reagent to the contaminated slurry while the slurry is passing through the mixing apparatus. In yet another aspect, the at least one chemical reagent is added in powder or liquid form. In yet a further aspect, the method includes adding at least one chemical reagent to the contaminated slurry before it is pumped into the mixing apparatus. In another aspect, the contaminants include at least one of polyfluoroalkyl substances (PFAS); hydrocarbons; metals; polychlorinated biphenyls (PCBs); dioxins; and chlorinated dibenzofurans (furans). In an aspect, the method further includes adding heat to the contaminated slurry before it is pumped into the mixing apparatus.

In another aspect of the disclosure, there is provided an apparatus for treatment of contaminated soil including a slurry tank for mixing contaminated soil with process water to produce a contaminated slurry; a mixing apparatus for generating a mass transfer of contaminants from soil to the process water, the mixing apparatus including a set of screens positioned between mixing chambers for increasing dissipation rates within the mixing chambers downstream from the mixing screens; and a slurry pump for pumping the slurry through the mixing apparatus at a predetermined velocity.

In a further aspect, the apparatus further includes at least one filter for filtering the contaminated soil before it enters the slurry tank for mixing. In yet another aspect, the at least one filter is a wet trommel or a linear motion screen. In another aspect, the apparatus includes a dewatering component for receiving treated soil and contaminated process water after the contaminated slurry has passed through the mixing apparatus; wherein the dewatering component separates the treated soil from the contaminated process water. In yet another aspect, the apparatus further includes a water treatment apparatus for treating the contaminated process water. In an aspect, the water treatment apparatus is connected with the slurry tank to provide treated process water.

### BRIEF DESCRIPTION OF THE DRAWINGS

Some embodiments of the present disclosure are illustrated as an example and are not limited by the figures of the accompanying drawings, in which like references may indicate similar elements and in which:

FIG. 1a is a schematic diagram of a first embodiment of a mixing apparatus;

FIG. 1b is a schematic diagram of a second embodiment of a mixing apparatus;

FIG. 2 is a schematic diagram of a soil treatment system including a mixing apparatus;

FIG. 3 is a schematic diagram of another soil treatment system including a mixing apparatus;

FIG. 4 is a schematic diagram of a third embodiment of a soil treatment system including a mixing apparatus;

FIG. 5 is a schematic diagram of a fourth embodiment of a soil treatment system including a mixing apparatus;

FIG. 6 is a schematic diagram of a fifth embodiment of a soil treatment system including a mixing apparatus; and

FIG. 7 is a table showing results of treatment of PFAS-impacted soil using the mixing apparatus of the disclosure vs treatment of PFAs-impacted soil using regular stirred mixing at 300 revolutions per minute.

### DETAILED DESCRIPTION

Although the following detailed description contains many specifics for the purposes of illustration, any one of ordinary skill in the art will appreciate that many variations and alterations to the following details are within the scope of the disclosure. Accordingly, the following embodiments of the disclosure are set forth without any loss of generality to, and without imposing limitations upon, the claimed disclosure.

The disclosure is directed at methods and systems for the treatment of contaminated soils. Examples of contaminated soils include, but are not limited to, soils or soil-like materials or granular materials contaminated with substances such as, but not limited to, polyfluoroalkyl substances (PFAS), hydrocarbons, metals, polychlorinated biphenyls (PCBs), dioxins, chlorinated dibenzofurans (furans) and the like. In one embodiment, the system includes a mixing apparatus that includes a set of mixing sections or compartments that are separated by a set of mixing screens.

In some embodiments, when the soil is contaminated with PFAS, the PFAS-laden soil is mixed with water or processing water to create a slurry that is pumped through the mixing apparatus to separate the PFAS from the soil such that the PFAS are desorbed into the water (or mixed into an aqueous phase) which results in PFAS-laden water and treated soil. It is understood that the process, method or apparatus of the disclosure may also be used for soils, soil-like materials or granular materials contaminated with other contaminants or substances.

While the following description refers to the treatment of PFAS-laden soil, it is understood that the disclosure may also be used for the treatment of other soils, soil-like materials or granular materials contaminated with hydrocarbons, metals, PCBs, dioxins, furans and the like.

Current PFAS soil treatment processes designed to transfer PFAS sorbed soil particles to an aqueous phase (or a process liquid, such as water) are inefficient because the transfer of PFAS from the soil is a mass-transfer limited reaction. In these types of current reactions, the mass transfer limitations may be overcome by increasing the energy input to the reactor performing the treatment. The energy dissipation rate can be used as a measure of the amount of energy lost by the viscous forces during a turbulent flow condition and is an indirect measure of the energy input to a fluid system or the reactor.

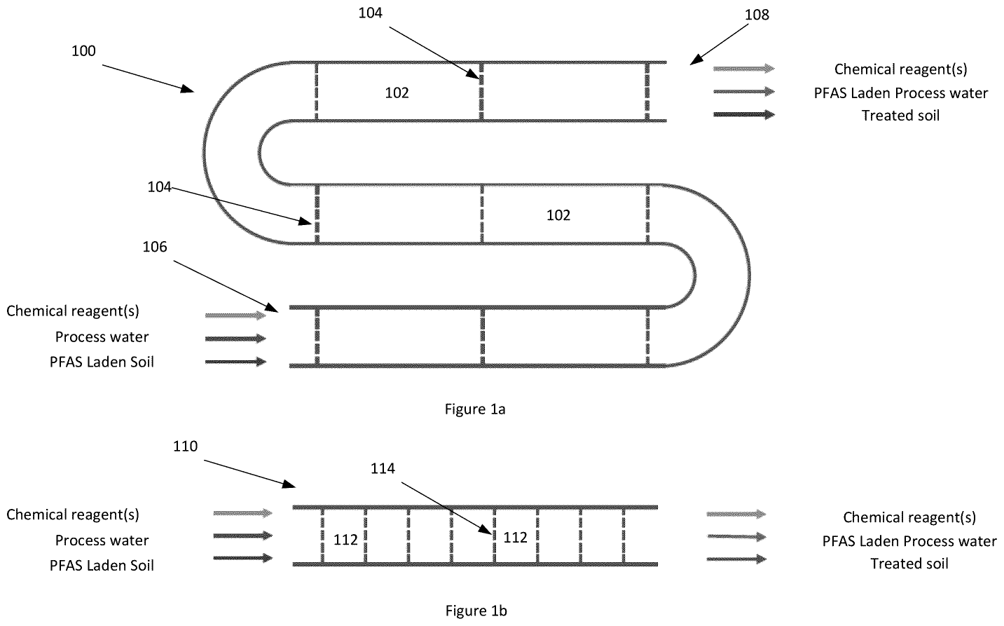

In the disclosure, to increase the energy input and overcome current PFAS mass transfer limitations or other contaminant mass transfer limitations, the soil treatment methods and systems of the disclosure include a mixing apparatus that increases the mass transfer of sorbed contaminants from soil to water. FIGS. 1a and 1b show two embodiments of a mixing apparatus in accordance with the disclosure. The mixing apparatus of either one of FIG. 1a or 1b may be used as a stand-alone mixing apparatus or may be integrated within a soil treatment system.

Turning to FIG. 1a, a schematic diagram of a first embodiment of a mixing apparatus for treating contaminated soil, such as, but not limited to, PFAS contaminated soil is provided. The current embodiment may be seen as a long residence time embodiment which may be used when the contaminated soil needs to be treated for a predetermined period of time. In one embodiment, the mixing apparatus may be used to treat sand and silt/clay sized soil particles.

In the current embodiment, the mixing apparatus 100 includes a set of mixing sections or compartments 102 that are divided or separated by a set of mixing screens 104 or grids. In some embodiments, the distance or spacing between each of the mixing screens 104 is variable depending on parameters such as, but not limited to, the gradation size of the soil and the concentration of the contaminant in the soil.

In some embodiments, the screen spacing can vary from about 12.5 mm to over 1 meter. More specifically, the spacing between screens 104 may be between about 25 mm to about 50 mm. In further embodiments, the spacing and residence time (the time the contaminated soil remains or is being passed through the mixing apparatus) for a given contaminated soil and contaminant concentration may be determined through testing. In yet further embodiments, the contaminated soil may be treated multiple times in order to meet the residence time requirement.

In use, the energy dissipation generated downstream of each individual screen 104 may be controlled by the upstream velocity or average velocity of the slurry along with screen characteristics such as, but not limited to, a mesh size, a wire bar rod size and/or a fractional open area of the screen. Typical velocities may be from about 0.5 m/s to about 3 m/s but can be varied based on the specific soil and contaminant profile.

The grids or screens 104 can be constructed in various configurations, but, in one specific embodiment, a finer grid/screen may be constructed with crimped double-weave screens, whereas a coarser screen may be constructed of crimped double-weave screens or punch plate with five mm or greater sized openings in the plate. For the coarser meshed screens, abrasion resistant coatings such as, but not limited to, rubber or ceramic can be applied to facilitate processing of the coarser grained particles.

For some specific examples, for fine grained soils, screens having a 70×70 mesh with a wire size of about 159 μm, a mesh spacing of about 362 μm, and an approximate 33% open area can be utilized. For embodiments that treat coarser soils, screens having mesh sizes as high as 10 mesh or greater with rubber, ceramic or other abrasion resistant coatings can be utilized in either a crimped double-weave or punch plate style.

In some embodiments, the screens 104 are oriented perpendicular to the flow of liquid or slurry in the pipe or mixing apparatus 100 whereby each screen 104 creates a uniform turbulence region directly behind/downstream of the screen in high velocity pipe flows. The very high turbulence intensities generated in the regions of mixing sections 102 adjacent to the screens 104 result not only in the formation of finely-dispersed bubbles and/or drops but an increased mass transfer coefficient.

The mixing apparatus 100 may be seen as a pipeline system with an input end 106 and an output end 108.

In the current embodiment, the mixing apparatus 100 is designed in a snake-like shape but it is understood that other orientations of the set of mixing sections 102 are contemplated. These other orientations may include, but are not limited to, a straight line, a recirculating loop, in a circular pattern that increases in height or as a series of pipes arranged in parallel with the flow split to increase throughput. The length and configuration of the mixing apparatus may depend upon at least one of a required residence time in the mixing apparatus, the number of screen elements required and/or the footprint of the space the mixing apparatus is being run.

In use, the mixing apparatus 100, receives at its input 106, PFAS-laden soil and a liquid, such as process water, which are mixed together to form a slurry. The slurry may also be mixed with other one or more chemical reagents or chemical reactants to adjust the characteristics of the slurry. The chemical reagents may be added to the slurry mixture in either a solid (such as a powder) or a liquid form. This will be described in more detail below. The set of mixing screens 104 are positioned within the mixing apparatus 100 to increase energy and to overcome current PFAS mass transfer limitations as the slurry travels within the mixing apparatus 100.

In some embodiments, each of the mixing screens 104, or mixing grids, create or generate regions or areas within the mixing apparatus 100 with high or very high energy dissipation rates such as 40000 W/kg or higher. The dissipation rates may be controlled via the characteristics of the mixing screens 104 such as, but not limited to, a mesh size of each mixing screen 104 or a thickness of the wire of each mixing screen 104. The characteristics of the mixing screens 104 may also be selected with respect to an expected velocity or viscosity of the flow of slurry as it passes through the mixing apparatus 100.

In some embodiments, a region of high turbulent energy dissipation may be generated or created for very short durations after the slurry passes each mixing screen 104. For a given screen geometry and construction, the energy dissipation rate can also be increased by increasing the velocity of the slurry flow in the mixing apparatus. The average dissipation rate per unit volume may be further increased by decreasing the inter-screen spacing.

The regions of high turbulent energy dissipation create an area of turbulence that promote contact between solid and liquid phases or portions of the slurry thereby enabling the mass transfer of PFAS or contaminants from the solid (or soil) portion of the slurry to the liquid (or water) portion of the slurry whereby an output of the mixing apparatus 100 includes PFAS-laden water and treated soil. If previously added, the output may also include the chemical reagents.

Current treatment systems often use mechanically agitated tanks to separate the PFAS from the PFAS-laden soil. These tanks typically have maximum energy dissipation rates of 100 watts per kilogram (W/kg) as measured directly at the mixing impeller. Lesser or slower dissipation rates are experienced in areas of the tank that are farther away from the impeller. For the mixing apparatus 100 of the disclosure, dissipation rates up to about 40,000 W/kg or more may be achieved resulting in a significant increase in the energy input to the mixing apparatus compared with current treatment systems.

In some embodiments, a range of energy dissipation rates can be generated by varying the number and/or characteristics of the static mixing elements or mixing screens 104 within the mixing apparatus 100 for the treatment of a contaminated soil.

Another advantage of the disclosure is that by using the mixing apparatus (in the form of mixing screens 104), one or more chemical reagents may be introduced into the slurry at different locations along the mixing apparatus 100 to aid in further enhancing the transfer of sorbed PFAS from the soil or slurry to the process water. Additionally, in some embodiments, the chemical reagents may be introduced at the input 106 of the mixing apparatus 100 while in other embodiments, the chemical reagents may be introduced into different mixing sections 102 of the mixing apparatus, or both at the input 106 and different mixing sections 102. Examples of chemical reagents include, but are not limited to, surfactants, solvents, acids, bases or salts. Surfactants may include, but are not limited to, anionic, non-ionic, cationic or biological surfactants such as, but not limited to, rhamnolipids. Solvents may include, but are not limited to, acetone, hexane, isopropanol, or solvents such as methanol, ethanol as either pure alcohols or diluted with water at percentages varying from about 10% to about 50%. Other solvents may include green solvents, lactic acid or ethyl lactate. Acids may include, but are not limited to, hydrochloric acid, sulfuric acid, nitric acid and the like. Bases may include, but are not limited to, sodium hydroxide and the like. Salts may include, but are not limited to, sodium chloride or calcium chloride and the like.

In some embodiments, by configuring the mixing apparatus 100 within a pipeline, a larger surface area to volume ratio condition may be created which allows the treatment process to be performed at a predetermined temperature to further enhance the transfer of PFAS to the aqueous phase (or from the soil to the process water) within the mixing apparatus 100.

Turning to FIG. 1b, a schematic diagram of another embodiment of a mixing apparatus is shown. The current embodiment may be seen as a high intensity mixing apparatus. In the current embodiment, the mixing apparatus 110 includes a set of mixing sections 112 that are separated by a set of mixing screens 114. In this embodiment, the mixing screens 114 may be placed about 1 inch apart. Geometry and construction of the screens may be the same as discussed above with respect to the mixing apparatus of FIG. 1a.

Due to the smaller mixing sections 112, the slurry may pass through more mixing screens 114 in a shorter amount of time or distance (in comparison with the embodiment of FIG. 1a) thereby increasing the average dissipation rate per unit volume of each mixing apparatus with the smaller spacing between screens.

As with the embodiment of FIG. 1a, input into the mixing system 110 may be seen as a slurry that includes process water and PFAS-laden soil (and chemical reagents, if desired) while the output (after passing through the mixing apparatus 110) includes PFAS laden process water, treated soil and chemical reagents, if added.

Integration or application of a mixing apparatus 100 or 110 of the disclosure into a larger soil treatment system may be performed in different manners. For example, PFAS-laden soil or contaminated soil that is sand-sized or smaller can be fed directly into a slurry tank (where water, or a liquid, is added) and then pumped (such as via a slurry pump) into or through the mixing apparatus. For contaminated soils that have a gradation with particles greater than the sand-sized granules, the soil or slurry can be prepared for processing though the mixing apparatus by filtering the PFAS-laden soil before or after it is turned into a slurry.

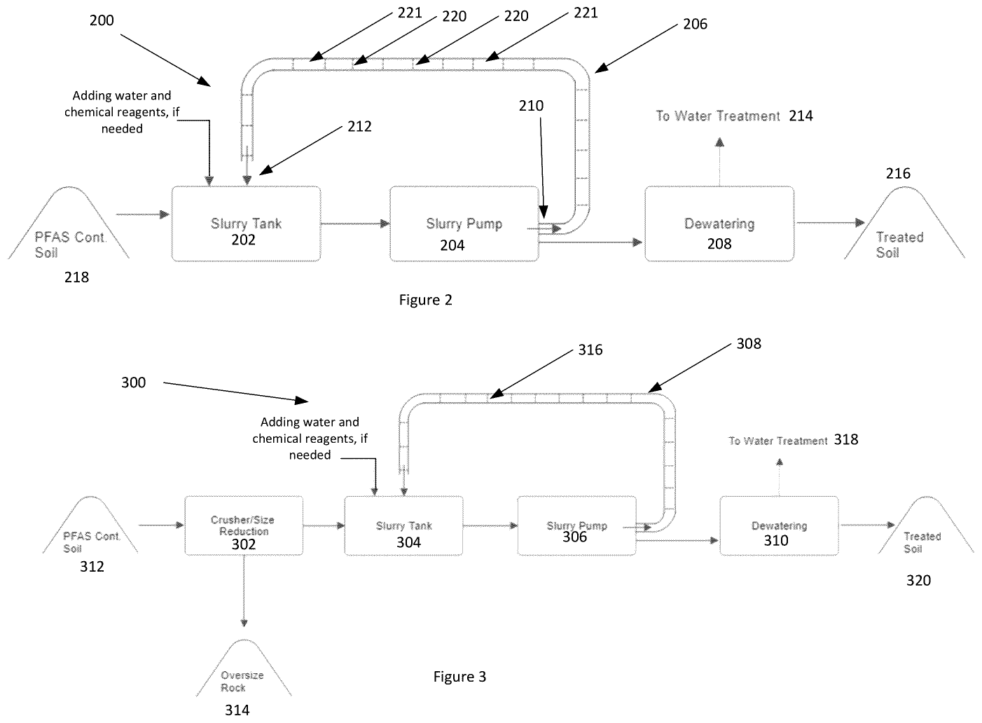

FIGS. 2 to 6 are schematic diagrams of different soil treatment systems that may address some of these scenarios. In the following figures, the soil treatment systems may include at least one size reduction apparatus such as, but not limited to, jaw-or cone-crusher machinery, dry screening or filtering components, wet screening or filtering components or soil washing components.

Turning to FIG. 2, a soil treatment system 200 includes a slurry tank 202 along with a slurry pump 204 and a mixing apparatus 206. The system 200 may also include a dewatering component or dewatering station 208. As can be seen in the current embodiment, an input 210 of the mixing apparatus 206 is connected to an output of the slurry pump 204 while an output 212 of the mixing apparatus 206 is connected to the slurry tank 202. In some embodiments, the slurry may be recirculated through the mixing apparatus 206 multiple times to meet a predetermined mixing, or residence, time to transfer the PFAS or contaminants from the soil to the water before being directed towards the dewatering component 208.

As shown in FIG. 2, in one mode of operation, PFAS contaminated soil 218 is passed through or to the slurry tank 202 where it is combined with water (where needed) and chemical reagents, if desired, to create or produce a slurry. The PFAS contaminated soil (now in the form of a slurry) is then passed to the slurry pump 204 that pumps the slurry through the mixing apparatus 206 back to the slurry tank 202.

As discussed above, the mixing apparatus 206 includes a set of mixing screens 220, located between mixing sections 221, within the flow or path of the slurry as it moves from the slurry pump 204 to the slurry tank 202. Examples of mixing apparatus are shown in FIGS. 1a and 1b.

As the slurry passes through the mixing apparatus 206, the PFAS within the soil is separated or treated and mixed with the process water or liquid portion of the slurry or, in other words, the PFAS in the soil are transferred to the water. The treated slurry is then output to the slurry tank 202 and passed to the slurry pump 204. This treated slurry may then be pumped again through the apparatus 206 or may be passed to the dewatering component 208. A determination of when the treated slurry is ready to be passed to the dewatering component 208 may be based on a desired or required residence time of the slurry within the mixing apparatus 206. In other words, pumping the slurry through the mixing apparatus more than once allows the residence time to be increased with the same configuration of piping and mixers to accommodate different soils and initial contaminant concentrations.

In some embodiments, only a portion of the treated slurry is passed to the dewatering component 208 while a remainder of the treated slurry is recirculated through the mixing apparatus 206.

For the treated slurry that is passed to the dewatering component 208, a liquid or water portion (or PFAS-laden liquid portion) of the treated slurry is directed, filtered or separated from the soil or solid portion and then passed to a water treatment facility or component 214 for further treatment and the non-liquid portion (which may be seen as a treated soil or treated solid portion) may be collected in a soil collection area 216.

Turning to FIG. 3, another embodiment of a soil treatment system 300 is shown. The soil treatment system 300 includes a soil size reduction component or apparatus 302, a slurry tank 304, a slurry pump 306 and a mixing apparatus 308. The system 300 may also include a dewatering component or dewatering station 310.

In the current embodiment, the soil size reduction component 302 may be used to reduce a size of the particles within PFAS-laden soil 312 by crushing or filtering out larger particles within the soil 312. In some embodiments, the soil particles may be reduced to a size of granules of sand or less thereby allowing or facilitating processing of the soil or slurry through the mixing apparatus 308.

The soil treatment system 300 of FIG. 3 is similar to the soil treatment system 200 of FIG. 2 with the addition of the size reduction apparatus 302. In operation, the PFAS laden soil 312 is passed through the size reduction apparatus 302 which reduces the size of the particles in the PFAS-laden soil 312. In some embodiments, larger particles may be separated from the PFAS laden soil and then collected in a rock, or large particle, collection area 314. As discussed above, the size reduction apparatus 302 reduces the size of individual particles of the soil by removing, crushing or filtering rocks or objects of a predetermined size from the PFAS-laden soil to improve the soil treatment.

The filtered PFAS-laden soil is then passed to the slurry tank 304. As with the embodiment of FIG. 2, after the filtered PFAS contaminated soil is passed through or to the slurry tank 304, the soil may be combined with water (where needed) and chemical reagents or reactants, if desired, to create a slurry. The filtered PFAS contaminated soil (now in the form of a slurry) is then passed to the slurry pump 306 that pumps the slurry through the mixing apparatus 308 back to the slurry tank 304.

As discussed above, the apparatus 308 includes a set of mixing screens 316 located within the flow or path of the slurry as it moves from the slurry pump 306 to the slurry tank 304. As the slurry passes through the apparatus 308, the PFAS within the soil are separated or treated and mixed with the water or liquid portion of the slurry or transferred to the water or liquid portion. The treated slurry is then output to the slurry tank 304 and passed to the slurry pump 306. The treated slurry may then be pumped again through the mixing apparatus 308 or may be passed to the dewatering component 310. When the treated slurry is ready to be passed to the dewatering component 310 may be based on a desired or required residence time of the slurry within the mixing apparatus.

For the treated slurry that is passed to the dewatering component 310, a liquid portion (or PFAS laden liquid portion) of the treated slurry is separated by a dewatering process and then directed a to water treatment facility or component 318 for further treatment and the non-liquid portion (which may be seen as a treated soil or treated solid portion) is collected in a collection area 320.

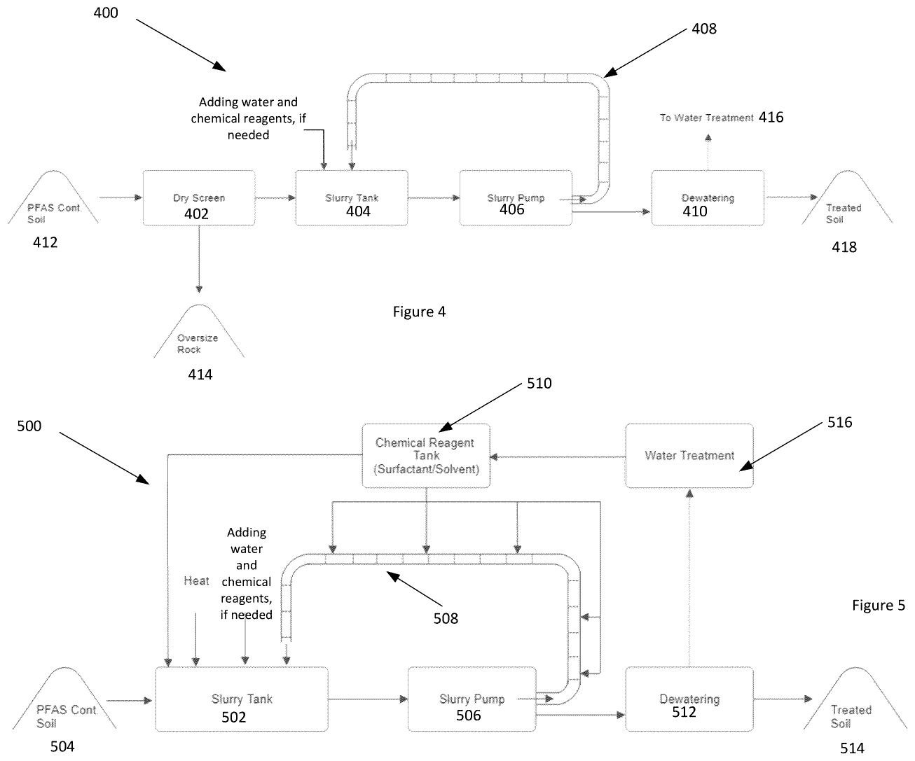

Turning to FIG. 4, a schematic diagram of another embodiment of a soil treatment system is shown. The soil treatment system 400 includes a dry screen filter component 402, a slurry tank 404, a slurry pump 406 and a mixing apparatus 408. The system 400 may also include a dewatering component or dewatering station 410.

In the current embodiment, the dry screen component 402 may be used to separate or filter out any gravel, rocks and/or larger sized soil fractions in the PFAS laden soil 412 that are above a pre-requisite size before it is passed to the slurry tank 404. The separated or filtered out parts or fractions are then collected in a collection area 414. Operation of the soil treatment system 400 after the PFAS laden soil 412 has been passed through the dry screen component 402 to the slurry tank 404 is identical to the process discussed above with respect to FIGS. 2 and 3.

After the soil enters the slurry tank 402, water and chemical reagents (if needed), may be added to the slurry tank 402 to turn the soil into a slurry which is pumped through the mixing apparatus 408 by the slurry pump 406. The slurry pump 406 may also pump the treated slurry to the dewatering component 410 so that the PFAS-laden water can be directed to a water treatment component 416 and the treated soil collected in a collection area 416.

Turning to FIG. 5, a schematic diagram of another embodiment of a soil treatment system is shown. The embodiment of FIG. 5 is similar to the embodiment of FIG. 2 with the addition of heat and/or chemical reagents at different points within the soil treatment system to further enhance desorption of PFAS from the PFAS laden soil to the process water as it is processed through the soil treatment system.

The soil treatment system 500 includes a slurry tank 502 that receives PFAS laden soil 504. Heat and water are inputted or added to the slurry tank 502 as the soil 504 passes through to produce a slurry. As with the other embodiments, at least one chemical reagent may also be added to the slurry tank 502. The slurry is then passed from the slurry tank 502 to a slurry pump 506 that pumps the slurry through a mixing apparatus 508 to treat the soil by separating the PFAS from the soil into the water. As the slurry passes through the mixing apparatus 508, the PFAS in the soil mix with the water and are separated from the soil. In the current embodiment, the system 500 further includes a chemical reagent tank 510 that releases a chemical (such as, but not limited to, a surfactant or a solvent) into a predetermined number of mixing sections within the mixing apparatus 508. The chemical reagent may also be added to the slurry tank 502, as discussed above.

As with the embodiment of FIG. 2, when the slurry enters the slurry pump 506, the pump 506 may also pass its output to a dewatering component 512 (assuming that the slurry has met predetermined criteria) that filters the treated slurry to separate or direct the treated soil to a collection area 514 and the PFAS laden water to a water treatment component 516. The treated water may then be passed to the chemical reagent tank 510 or may be passed to the slurry tank 502 to be used to produce the slurry.

In operation, the heat that is inputted into the slurry tank 502 is used to adjust a temperature profile of the water from an ambient temperature to a higher predetermined temperature, such as, but not limited to, 100 degrees Celsius. In some embodiments, the chemical reagents may include, but are not limited to, acids and bases to adjust a pH level of the process water. In other embodiments, at least one chemical reagent may be cationic, anionic and non-ionic surfactants added in concentrations ranging from a few parts per million to levels in excess of their respective critical micelle concentrations and/or solvents such as, but not limited to, methanol and ethanol in varying concentrations in the process water ranging from about 10 to about 99 percent (w/w). In one specific embodiment, the chemical reagent is ethanol at a concentration of 50 percent (w/w) with respect to the process water.

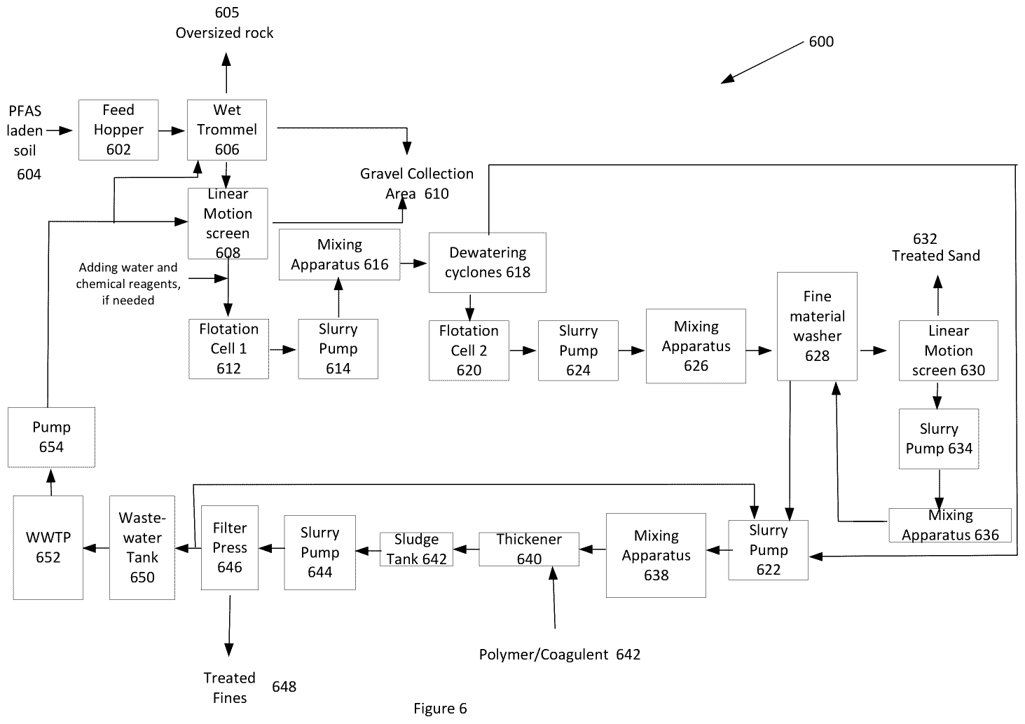

Turning to FIG. 6, another schematic diagram showing an embodiment of a soil treatment system is shown. The embodiment of FIG. 6 includes a soil washing flowsheet with at least one mixing apparatus incorporated into the process piping at select locations to process the sand and silt/clay sized soil fractions. This embodiment may be seen as a soil treatment system that includes turbulent mixers in an ex-situ soil washing process.

The soil treatment system 600 includes a metered feed hopper 602 that receives the PFAS laden soil 604. An output of the feed hopper 602 is connected to a wet trommel component 606 that performs a filtering functionality to reduce the size of the particles of the PFAS laden soil 604. In one embodiment, the wet trommel component 606 separates out rocks that are larger than a first predetermined size, such as, but not limited to, about 50 mm which are collected in collection area 605. The trommel component 606 may also filter out particles or gravel that is smaller than the first predetermined size but larger than a second predetermined size, such as, but not limited to, about 5 mm and collected in collection area 610.

The remaining PFAS laden soil 604 is then passed from the trommel component 606 to a linear motion screen component 608 which may filter out gravel or particles that are larger than a third predetermined size, such as, but not limited to, about 2 mm. The materials that are filtered out by the screen component 608 may also be collected in collection area 610 which may be seen as a gravel collection area 610. The filtered out material may then be mixed with water and, if necessary, at least one chemical reagent, to produce a slurry.

An output of the screen component 608 is connected to a first flotation cell 612 that may be used to remove PFAS from the process water through a physical-chemical separation between the PFAS and the microbubbles generated by the flotation cell 612 and the PFAS. The PFAS are removed and concentrated from the process water and collected as a froth at the surface of the flotation cell and removed from the system 600. The flotation cell 612 may also be used as a low intensity mixer with the energy input from a Rushton style impeller and the turbulence created from the air bubbles. For other contaminants such as PCBs, hydrocarbons or certain metals, the flotation cell 612 can also be used to selectively remove the hydrophobic contaminants or remove the contaminants after conditioning with a collector chemical reagent. A PFAS laden soil slurry output of the cell 612 is connected to a slurry pump 614. As with the other embodiments, at least one chemical reagent may also be added at the input to the slurry pump 614. The slurry pump 614 then pumps the slurry through a mixing apparatus 616 which separates or transfers the PFAS from the soil to the water. After passing through the mixing apparatus 616, the treated soil and the PFAS laden water are directed at a dewatering component (which may be seen as a set of dewatering cyclones 618). In the current embodiment, outputs of the dewatering cyclones 618 are directed towards a second flotation cell 620 (such as in the form of separated sand) and another slurry pump 622 (such as in the form of fine-grained soil slurry).

In other embodiments, the dewatering cyclones 618 may also separate the fines (silt and clay <about 75 μm) from the sands from the soil. The dewatered sands are then transported to the second flotation cell 620 for processing with PFAS free process water in a low intensity mixing environment of the flotation cell 620 to help transfer PFAS from the soil to the process water as well as collect PFAS from the process water as a froth to be removed from the system.

An output of the second flotation cell 620 is connected to another slurry pump 624 that may pump the received slurry through another mixing apparatus 626 to a fine material washer component 628 for dewatering.

One output from the material washer component 628 is connected to a second linear screen component 630 which filters out a solid portion output to remove treated sand from the output and to direct the treated sand to a treated sand collection area 632. A remainder of the output is passed to a slurry pump 634 which pumps the remaining portion (which may include PFAS laden water and some soil) through another mixing apparatus 636 back to the fine material washer component 628. Another output of the fine material washer component 628 is connected to slurry pump 622. Slurry pump 622 then pumps the received slurry through another mixing apparatus 638 to a thickener component 640 that receives a polymer and/or coagulant 642 to clarify the process water and thicken the slurry. In some embodiments, the fine-grained soils that are separated by the dewatering cyclone 618 and transported to the pump 622 are pumped through a series of mixing screens (or another mixing apparatus 638) in the piping that connects the slurry pump to the thickener component 640. In some embodiments, the screens in this mixing apparatus 638 may be designed for fine grained soils by including smaller meshed crimped double-weaved screens.

An output of the thickener component is connected to a sludge tank component 642 which, in turn, is connected to a slurry pump 644. The slurry pump 644 pumps the slurry or sludge to a filter component 646 that filters out treated fine particulates towards a treated fines collection area 648. The non-filtered liquid portion is then passed to a wastewater tank 650 and the remaining non-liquid portion is passed back to the slurry pump 622.

An output of the wastewater tank may be passed to a wastewater treatment plant (WWTP) 652 to treat the wastewater which may then be pumped (via pump 654) to the wet trommel component 606 to assist in the wet filtering of the output from the feed hopper 602.

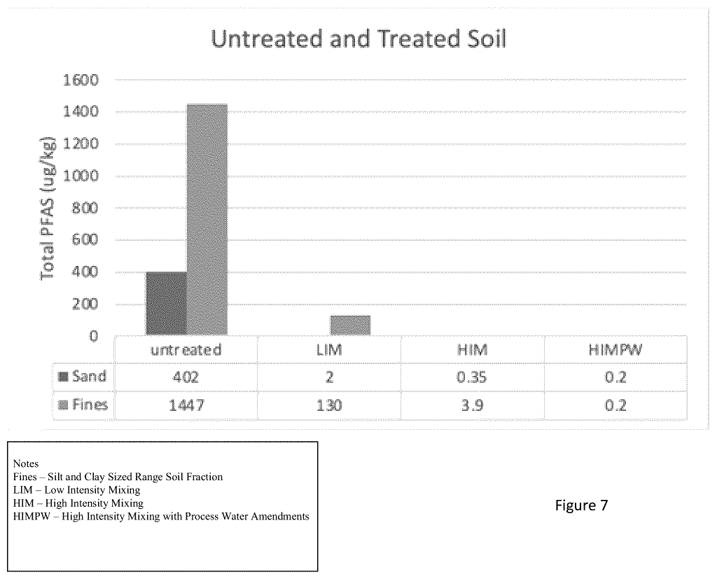

Turning to FIG. 7, a chart showing untreated and treated PFAS concentrations in different soil gradations is provided. More specifically, the table shows results from laboratory scale trials on PFAS-laden sand and PFAS-laden fines (silt and clay) soil fractions subjected to the process conditions of a mechanically agitated tank at 300 rpm or Low Intensity Mixing (LIM) which represents the state of the art and High Intensity Mixing (HIM) using the mixing apparatus of the disclosure and High Intensity Mixing (using the mixing apparatus of the disclosure) with a chemically amended water (HIMPW).

As seen FIG. 7, the soil processed or treated under high intensity (indicated by HIM or HIMPW) showed significant PFAS concentration reductions as compared to the soil processed via LIM. This is especially evident in the fine-grained soils (fines) where reductions of total PFAS increased in a range of 82 to >99 percent as compared to the LIM treated soils.

The degree of PFAS contamination reduction when treated using the mixing apparatus of the disclosure (with or without reactants in the water) reduced the total PFAS concentration to levels that would meet current regulatory criteria.

It will be clear to one skilled in the art that the above embodiments may be altered in many ways without departing from the scope of the disclosure.

What is claimed is:

1. A method for treating contaminated soil comprising:
mixing the contaminated soil with process water to produce a contaminated slurry; and
pumping the contaminated slurry through a mixing apparatus to separate the contaminants from the soil thereby increasing a mass transfer of sorbed contaminants from the contaminated soil into the process water and producing a treated soil and a contaminated process water;
wherein the mixing apparatus includes a set of mixing chambers separated by a set of mixing screens, the mixing screens positioned to increase dissipation rates within the mixing chambers downstream from the mixing screens.

2. The method of claim 1 further comprising:
filtering the contaminated soil to reduce a size of particles within the contaminated soil before mixing the contaminated soil with process water.

3. The method of claim 1 further comprising:
passing the treated soil and the contaminated process water to a dewatering component.

4. The method of claim 3 further comprising:
directing the contaminated process water to a water treatment apparatus; and
collecting the treated soil in a collection area.

5. The method of claim 1 further comprising:
pumping the contaminated slurry through the mixing apparatus a predetermined number of times to meet a required residence treatment time for the contaminated soil.

6. The method of claim 1 further comprising:
adding at least one chemical reagent to the contaminated slurry while the slurry is passing through the mixing apparatus.

7. The method of claim 6 wherein the at least one chemical reagent is added in powder or liquid form.

8. The method of claim 1 further comprising:
adding at least one chemical reagent to the contaminated slurry before it is pumped into the mixing apparatus.

9. The method of claim 8 wherein the at least one chemical reagent is added in powder or liquid form.

10. The method of claim 1 wherein the contaminants comprise at least one of polyfluoroalkyl substances (PFAS); hydrocarbons; metals; polychlorinated biphenyls (PCBs); dioxins; and
chlorinated dibenzofurans (furans).

11. The method of claim 1 further comprising adding heat to the contaminated slurry before it is pumped into the mixing apparatus.

12. An apparatus for treatment of contaminated soil comprising:
a slurry tank for mixing contaminated soil with process water to produce a contaminated slurry;
a mixing apparatus for generating a mass transfer of contaminants from soil to the process water, the mixing apparatus including a set of screens positioned between mixing chambers for increasing dissipation rates within the mixing chambers downstream from the mixing screens; and
a slurry pump for pumping the slurry through the mixing apparatus at a predetermined velocity.

13. The apparatus of claim 12 further comprising at least one filter for filtering the contaminated soil before it enters the slurry tank for mixing.

14. The apparatus of claim 13 wherein the at least one filter is a wet trommel or a linear motion screen.

15. The apparatus of claim 12 further comprising a dewatering component for receiving treated soil and contaminated process water after the contaminated slurry has passed through the mixing apparatus;
wherein the dewatering component separates the treated soil from the contaminated process water.

16. The apparatus of claim 15 further comprising a water treatment apparatus for treating the contaminated process water.

17. The apparatus of claim 16 wherein the water treatment apparatus is connected with the slurry tank to provide treated process water.
